(19) United States
(12) Patent Application Publication
(10) Pub. No.: US 2009/0178377 A1
(43) Pub. Date: Jul. 16, 2009

(54) WELDING SMOG DISPOSAL MACHINE PROVIDED WITH A HIGH PRESSURE CLEANING FILTER BARREL

(76) Inventor: Chieh-Yuan CHENG, Taichung City (TW)

Correspondence Address: SINORICA, LLC, 2275 Research Blvd., Suite 500, ROCKVILLE, MD, 20850, US

(21) Appl. No.: 11/972,127

(22) Filed: Jan. 10, 2008

(51) Int. Cl. B01D 50/00

(52) U.S. Cl. 55/385.1

(57) ABSTRACT

A welding smog disposal machine provided with a high pressure air cleaning filter barrel includes a machine box formed with a housing bored with a wind inlet and a wind outlet. The housing is assembled therein with a partition plate having one side disposed with a filter barrel communicating with the wind inlet and the other side mounted with a blower having an air intake communicating with the filter barrel, and an exhaust hole communicating with the wind outlet. A gas pressure container stored with high pressure air is installed at an outer side of the machine box and connected with an exhaust pipe having the other end passing through the partition plate and communicating with the filter barrel. High pressure air is released into the filter barrel through the exhaust pipe to remove dust and impurities from the surface of the filter barrel for cleaning.

### BACKGROUND OF THE INVENTION

1. Field of the Invention

This invention relates to a welding smog disposal machine provided with a high pressure cleaning filter barrel for carrying out air filtration.

2. Description of the Prior Art

Generally, when the automatic worktables of a metal welding factory are operated to carry out argon welding, electric welding or heat treatment, a great quantity of welding smog containing heavy metal volatile matter like lead, manganese and nickel, and much dust and embers will be produced to pollute the environment around. To solve foresaid problem, such a factory is provided with a welding smog disposal machine to carry out filtration of air for averting environmental pollution. However, during the electric welding work, lots of dust and impurities will be produced and, as a result, filter device will quickly be clogged with such dust and impurities; therefore the filter device has to be washed clean or replaced frequently for avoiding deteriorating the air around.

### SUMMARY OF THE INVENTION

The objective of this invention to offer a welding smog disposal machine provided with a high pressure cleaning filter barrel, including a machine box provided with a housing bored with a wind inlet and a wind outlet communicating with the wind inlet. The housing is assembled in the inner space with a partition plate having one side disposed with a filter barrel communicating with the wind inlet for filtrating dust and impurities and the other side mounted thereon with a blower having an air intake communicating with the interior of the filter barrel and an exhaust hole communicating with the wind outlet of the machine box. The machine box is further provided with a high pressure air unit consisting of a gas pressure container positioned at an outer side of the machine box and connected with an exhaust pipe threaded through the housing. The exhaust pipe has its end fixed with the partition plate and communicating with the interior of the filter barrel. When too much dust and impurities adhere to the surface of the barrel body of the filter barrel, high pressure air can instantly be released into the filter barrel through the exhaust pipe of the high pressure air unit, and simultaneously the high pressure air Stopped by a blind seal secured at the bottom of the filter barrel will move toward the circumference of the barrel body to remove the dust and impurities from the surface of the barrel body, thus enabling the filter barrel to continuously maintain good filtration effect and able to prolong service life of the filter barrel.

### BRIEF DESCRIPTION OF DRAWINGS

This invention will be better understood by referring to the accompanying drawings, wherein:

FIG. 1 is a perspective view of a welding smog disposal machine provided with a high pressure cleaning filter barrel in the present invention;

FIG. 2 is a cross-sectional view of the welding smog disposal machine provided with a high pressure cleaning filter barrel in the present invention; and

FIG. 3 is a side-sectional view of the welding smog disposal machine provided with a high pressure cleaning filter barrel in the present invention.

### DETAILED DESCRIPTION OF THE PREFERRED EMBODIMENT

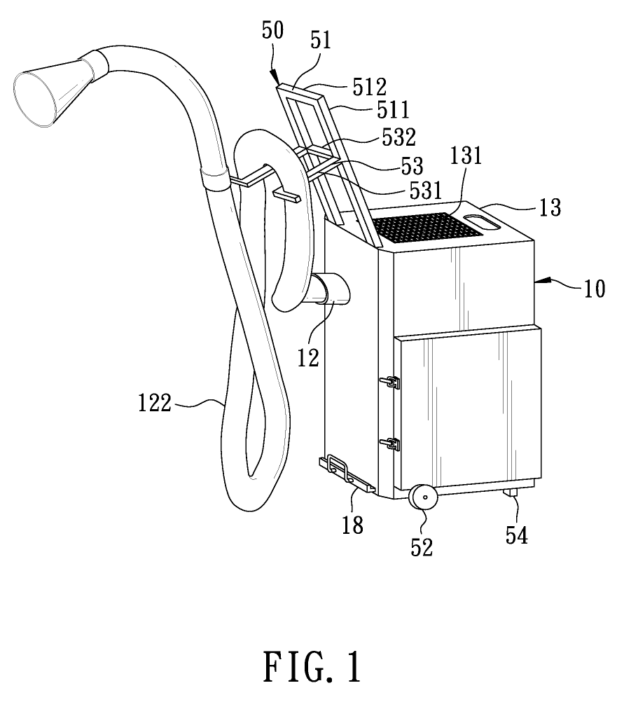

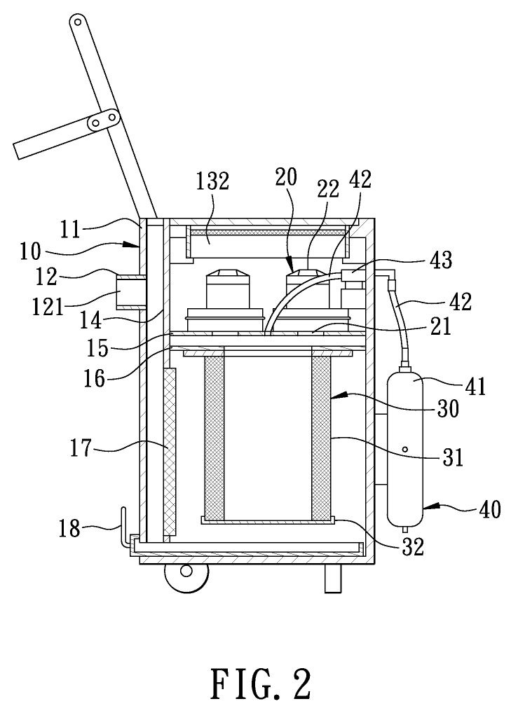

A preferred embodiment of a welding smog disposal machine provided with a high pressure cleaning filter barrel in the present invention, as shown in FIGS. 1 and 2, includes a machine box 10, two blowers 20, a filter barrel 30, a high pressure air unit 40 and a movable auxiliary unit 50 as main components combined together.

The machine box 10 is provided with a housing 11 having one side fixed with a fitting base 12 having a wind inlet 121 connected with a wind intake pipe 122 whose front end is made of fireproof PVC and whose rear end is made of heat-resisting PVC. The housing 11 has its topside assembled with a movable plate 13 bored with a wind outlet 131 communicating with the wind inlet 121 of the fitting base 12 and having its underside disposed with a filtration member 132 for filtrating fine-grained dust in the air. The housing 11 of the machine box 10 is provided inside with an upright plate 14 positioned vertically near the inner side of the wind inlet 121 of the housing 11 and having its lower end fixed with an aluminum filter plate 17 for obstructing embers. A first partition plate 15 is transversely assembled between the upright plate 14 and one side of the housing 11, opposite to the fitting base 12, to partition the housing 11 into two accommodating spaces, and a second partition plate 16 is transversely assembled under the first partition plate 15 and positioned at a location higher than the aluminum filter plate 17, having a buffer space formed between the first and the second partition plate 15 and 16. Further, the machine box 10 has its lower side flatly disposed with a drawer-shaped tray 18 for receiving dust and impurities.

The two blowers 20 are mounted on the first partition plate 15 and positioned between the first partition plate 15 and the filtration member 132, respectively con si sting of an air intake 21 and an exhaust hole 22 communicating with the wind outlet 131 of the machine box 10. The air intake 21 of the blowers 20 passes through the first partition plate 14.

The filter barrel 30 has its upper side passing through the lower end of the second partition plate 16 and communicating with the wind inlet 121 of the machine box 10. The filter barrel 30 consists of a barrel body 31 for filtrating dust and impurities, and a blind seal 32 made of hermetic material and secured at the bottom of the barrel body 31. In addition, the filter barrel 30 has its interior communicating with the air intakes 21 of the two blowers 20.

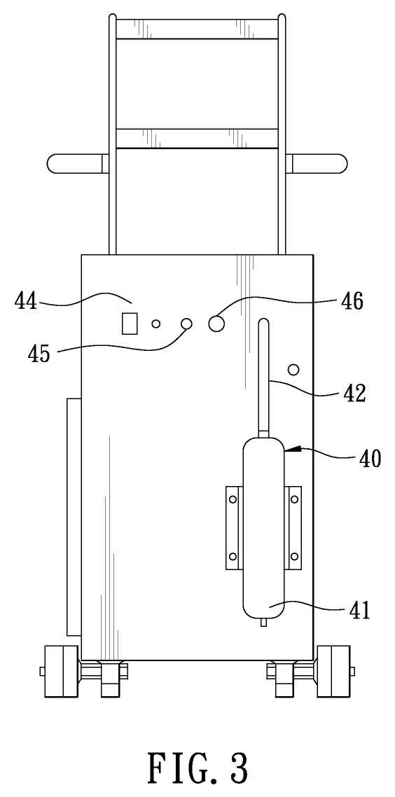

The high pressure air unit 40 includes a gas pre s sure container 41 positioned at an outer side of the machine box 10 and connected with an exhaust pipe 42, which has the other end inserted through the housing 11 and the first partition plate 15 to communicate with the interior of the filter barrel 30. Further, the exhaust pipe 42 is installed thereon with an electromagnetic valve 43 at an inlet of the exhaust pipe 42 in the wall of the machine box 10 for controlling discharge of high pressure air. Referring to FIG. 3, a control faceplate 44 is positioned beside the gas pressure container 41 and disposed thereon with an indicating lamp 45 for indicating the inner pressure of the machine box 10, and a switch press button 46 for starting the electromagnetic valve 43.

The movable auxiliary unit 50 is composed of a pull handle 51 and two casters 52. The pull handle 51 made of two parallel lengthwise rods 511 is obliquely assembled at one side of the top end of the machine box 10, and the two parallel lengthwise rods 511 have their upper ends connected by a cross bar 512. A pipe frame 53 made of two parallel L-shaped support rods 531 having their inner ends connected by a cross bar 532 and their outer ends respectively facing outward is secured at the intermediate portions of the two lengthwise rods 511 of the pull handle 51 for the wind intake pipe 122 to be held thereon. The two casters 52 are assembled at the underside of the machine box 10 and positioned at the same side of the pull handle 51, and two feet 54 are fixed at another side of the underside of the machine box 10.

To carry out electric welding, firstly, the welding smog disposal machine is moved to a working area by the pull handle 51 and the wind intake pipe 122 is temporarily held on the pipe frame 53 during moving of the smog disposal machine. In the course of electric welding, embers, dust and impurities produced will be pumped into the machine box 10 through the wind intake pipe 122. At this time, the embers obstructed by the aluminum filter plate 17 will drop into the drawer-shaped tray 18, while the dust and impurities will pass through the aluminum filter plate 17 to be filtrated by the barrel body 31 of the filter barrel 30. Subsequently, fine-grained dust will be filtered by the filtration member 132 and then exhausted out of the machine box 10, thus maintaining good quality of air of a working environment.

After the smog disposal machine has been used for a period of time, the indicating lamp 45 on the control faceplate 44 will give out light to warn a user that too much dust and impurities adhere to the surface of the barrel body 31 of the filter barrel 30 in the machine box 10 and the filter barrel 30 fails to carry out filtration effectively. Under the circumferences, the user has to press the switch press button 46 to start the electromagnetic valve 43 for instantly releasing high pressure air into the filter barrel 30 through the exhaust pipe 42. At this time, the blind seal 32 secured at the underside of the filter barrel 30 functions to stop the high pressure air from moving downward, and hence the high pressure air in the interior of the filter barrel 30 will be forced to move toward the circumference of the filter barrel 30 to remove dust and impurities from the surface of the barrel body 31 to let them drop into the drawer-shaped tray 18, thus needless to disassemble the filter barrel 30 frequently for cleaning and able to prolong service life of the filter barrel 30.

As can be understood from the above description, this invention has the following advantages.

1. When too much oily dirt and impurities adhere to the surface of the filter barrel in the machine box, simply press the switch press button to start the electromagnetic valve for immediately releasing high pressure air into the filter barrel through the exhaust pipe for removing impurities from the surface of the filter barrel, letting the impurities drop into the drawer-shaped holding tray, needless to disassemble the filter barrel frequently for replacing or cleaning.

2. Provided with two casters and a pull handle, the welding smog disposal machine of this invention can easily be moved about for tallying with different working environment.

3. The welding smog disposal machine of this invention is disposed in the interior with three filtration stages respectively provided with different filtration materials; therefore, after being filtrated, air will become completely unpolluted.

4. The pull handle of the welding smog disposal machine is provided with a pipe frame for holding the exhaust pipe thereon when the welding smog disposal machine is unused or is moved about.

While the preferred embodiment of the invention has been described above, it will be recognized and understood that various modifications mat be made therein and the appended claims are intended to cover all such modification that may fall within the spirit and scope of the invention.

I claim:

1. A welding smog disposal machine provided with a high pressure air cleaning filter barrel comprising:
a machine box formed with a housing bored with a wind inlet and a wind outlet communicating with said wind inlet, said machine box disposed inside with one partition plate positioned between said wind outlet and said wind inlet, said partition plate partitioning said housing into two accommodating spaces communicating with each other;
a filter barrel assembled at one side of said partition plate in said machine box and positioned between said wind inlet and said partition plate, said filter barrel formed with a hollow circular barrel body and having a blind seal secured at the bottom of said barrel body, said barrel body having its surface obstructing dust and impurities from getting into said filter barrel;
one blower mounted at another side of said partition plate in said machine box and positioned between said wind outlet of said machine box and said partition plate, said blower bored with an air intake and an exhaust hole communicating with said wind outlet of said machine box, said air intake of said blower communicating with an interior of said filter barrel; and
a high pressure air unit assembled at an outer side of said machine box, said high pressure air unit provided with a gas pressure container stored therein with high pressure air and connected with an exhaust pipe, said exhaust pipe inserted through one side of said housing and connected with said partition plate, said exhaust pipe having its end inserted through said partition plate and communicating with interior of said filter barrel, high pressure air released into said barrel body and moved toward outside of said barrel body for removing dust and impurities from surface of said barrel body.

2. The welding smog disposal machine provided with a high pressure air cleaning filter barrel as claimed in claim 1, wherein said high pressure air unit is provided with an electromagnetic valve in said machine box at an entrance of said exhaust pipe for controlling discharge of high pressure air in said gas pressure container.

3. The welding smog disposal machine provided with a high pressure air cleaning filter barrel as claimed in claim 1, wherein said machine box has its surface disposed with a control faceplate having an indicating lamp for indicating clogging conditions of said filter barrel, and a switch press button for controlling said electromagnetic valve to release high pressure air.

4. The welding smog disposal machine provided with a high pressure air cleaning filter barrel as claimed in claim 1, wherein said machine box has its lower side assembled with a drawer-shaped tray for receiving dust and impurities dropping from a surface of said filter barrel in said machine box.

5. The welding smog disposal machine provided with a high pressure air cleaning filter barrel as claimed in claim 1, wherein said machine box is assembled with a movable auxiliary unit consisting of a pull handle and two casters, said pull handle composed of two parallel lengthwise rods secured at one side of a top end of said machine box, said two parallel lengthwise rods having their upper ends connected by a cross bar, said two casters assembled at an underside of said machine box and positioned at a same side of said pull handle.

6. The welding smog disposal machine provided with a high pressure air cleaning filter barrel as claimed in claim 5, wherein said pull handle is fixed thereon with a pipe frame made of two parallel L-shaped rods respectively secured at an intermediate portion of said two lengthwise rods of said pull handle, said two parallel L-shaped rods having their outer ends respectively facing outward, joint portions of said two lengthwise rods and said two L-shaped rods connected by a cross bar, said pipe frame provided for holding said wind intake pipe thereon.

7. The welding smog disposal machine provided with a high pressure air cleaning filter barrel as claimed in claim 1, wherein an aluminum filter plate is disposed in said machine box at a location adjacent to an inner side of said wind inlet for obstructing high-temperature embers to avoid causing combustion in said machine box.

8. The welding smog disposal machine provided with a high pressure air cleaning filter barrel as claimed in claim 1, wherein a filtration member is installed between said wind outlet and said exhaust hole of said blower for filtrating fine-grained dust in air to be exhausted.
